(19) United States
(12) Patent Application Publication
(10) Pub. No.: US 2012/0204183 A1
(43) Pub. Date: Aug. 9, 2012

(54) ASSOCIATIVE DISTRIBUTION UNITS FOR A HIGH FLOWRATE SYNCHRONIZER/SCHEDULE

(75) Inventors: Nimrod Bayer, Beer-Sheva (IL); Peleg Aviely, Kadima (IL); Shareef Hakeem, Nazareth (IL)

(73) Assignee: PLURALITY LTD., Netanya (IL)

(21) Appl. No.: 13/393,548

(22) PCT Filed: Sep. 1, 2010
(86) PCT No.: PCT/IB10/53924

§ 371 Date: Apr. 23, 2012

Related U.S. Application Data
(60) Provisional application No. 61/239,072, filed on Sep. 2, 2009.

(51) Int. Cl. G06F 9/46

(52) U.S. Cl. 718/102

(57) ABSTRACT

An apparatus (10) includes a first plurality of processor cores (200) and a Central Scheduling/Synchronization Unit (CSU, 110), which is coupled to allocate computing tasks for execution by the processor cores. A second plurality of Distribution Units (DUs, 2000) is arranged in a logarithmic network (1000) between the CSU and the processor cores and configured to distribute the computing tasks from the CSU among the processor cores. Each DU includes an associative task registry (2200) for storing information with regard to the computing tasks distributed to the processor cores by the DU.

### CROSS-REFERENCE TO RELATED APPLICATIONS

This application claims the benefit of U.S. Provisional Patent Application 61/239,072, filed Sep. 2, 2009, whose disclosure is incorporated herein by reference.

### FIELD OF THE INVENTION

The present invention relates generally to the field of multiprocessors, and particularly to methods and systems for task distribution and management within a multiprocessor system.

### BACKGROUND OF THE INVENTION

Multiprocessor systems are described in numerous references. For example, in U.S. Pat. No. 7,725,897, whose disclosure is incorporated herein by reference, Yoshiyuki describes systems and methods for increasing utilization of processors in a multiprocessor system by defining a strict real-time schedule and a pseudo-real-time schedule and dynamically switching between the strict real-time schedule and the pseudo-real-time schedule for execution of tasks on the processors. In one embodiment, a number of occupied entries in an output buffer is monitored. When the number meets or exceeds a first threshold, the pseudo-real-time schedule is implemented. When the number is less than or equal to a second threshold, the strict real-time schedule is implemented. In one embodiment, the pseudo-real-time schedule is determined using an asymptotic estimation algorithm, in which the schedules for multiple processors are merged and then load-balanced (potentially multiple times) to produce a schedule that uses less processing resources than the strict real-time schedule.

As a second example, in U.S. Pat. No. 5,832,261, whose disclosure is incorporated herein by reference, Kenichi et al. describe a parallel data processing control system for a parallel computer system having a plurality of computers and an adapter device connecting the computers to each other, where a first unit, which is provided in the adapter device, transfers pieces of data processing progress state information to the computers. The pieces of the data processing progress state information respectively indicate data processing progress states of the computers. A second unit, which is provided in each of the computers, holds the pieces of the data processing progress state information. A third unit, which is provided in each of the computers, holds management information indicating a group of computers which share a data process. A fourth unit, which is provided in each of the computers, determines whether or not the computers in the group have completed the data process on the basis of the pieces of the data processing progress state information and the management information.

As a third example, in U.S. Pat. No. 5,265,207, whose disclosure is incorporated herein by reference, Zak et al. disclose a parallel computer comprising a plurality of processors and an interconnection network for transferring messages among the processors. At least one of the processors, as a source processor, generates messages, each including an address defining a path through the interconnection network from the source processor to one or more of the processors which are to receive the message as destination processors. The interconnection network establishes, in response to a message from the source processor, a path in accordance with the address from the source processor in a downstream direction to the destination processors thereby to facilitate transfer of the message to the destination processors. Each destination processor generates response indicia in response to a message. The interconnection network receives the response indicia from the destination processor(s) and generates, in response, consolidated response indicia which it transfers in an upstream direction to the source processor.

Lastly, in U.S. Pat. No. 5,202,987, whose disclosure is incorporated herein by reference, Bayer et al. describe a high flow-rate synchronizer/scheduler apparatus for a multiprocessor system during program run-time, comprising a connection matrix, programmable to hold a task map, additional hardware components for monitoring and detecting computational tasks which are allowed for execution and a network of nodes for distributing to the processors information of computational tasks detected to be enabled by the central synchronization unit. The network of nodes possesses the capability of decomposing information on a pack of allocated computational tasks into messages of finer sub-packs to be sent toward the processors, as well as the capability of unifying packs of information on termination of computational tasks into a more comprehensive pack. A method of performing the synchronization/scheduling in a multiprocessor system of this apparatus is also described.

### SUMMARY

An embodiment of the present invention provides an apparatus, including a first plurality of processor cores and a Central Scheduling/Synchronization Unit (CSU), which is coupled to allocate computing tasks for execution by the processor cores. A second plurality of Distribution Units (DUs) is arranged in a logarithmic network between the CSU and the processor cores and configured to distribute the computing tasks from the CSU among the processor cores. Each DU includes an associative task registry for storing information with regard to the computing tasks distributed to the processor cores by the DU.

In disclosed embodiments, the CSU is configured to allocate the computing tasks by transmitting task allocation packs through the DUs in the logarithmic network to the processor cores. Typically, each DU includes a distribution box, which is configured to distribute the task allocation packs received by the DU among the DUs or processor cores in a subsequent level of the logarithmic network within a number clock cycles no greater than the number of the DUs or processor cores in the subsequent level.

Additionally or alternatively, the processor cores are configured, upon completing a computing task, to transmit task termination packs through the DUs in the logarithmic network to the CSU. The DUs may be configured to merge termination information contained in the termination packs and to convey the merged termination information to the CSU. Typically, the DUs are configured to transmit one of the merged termination packs in each clock cycle, with a latency of a single clock cycle.

In some embodiments, the processor cores are configured, upon becoming available or upon ceasing to be available to perform the computing tasks, to transmit availability packs through the DUs in the logarithmic network to the CSU. Typically, each DU includes a core registry, which is configured to keep track of the available processor cores responsively to the availability packs and to allocation packs transmitted by the CSU.

In disclosed embodiments, the associative task registry of each DU includes multiple entries. Each entry corresponds to a respective computing task distributed by the DU to the processor cores and includes an ID register, storing a unique code for the computing task, which is applied by the DU in associatively accessing the entries. In one embodiment, each entry in the associative task registry further includes an allocation count register, configured to keep a first count of the number of task instantiations allocated to the processor cores by the DU; a termination count register, configured to keep a second count of the number of the task instantiations for which the DU has received a termination pack; and a comparator, coupled to compare the first and second counts in order to determine a completion status of the respective computing task. The DUs may be configured to detect a partial completion status responsively to the allocation and termination count registers and to transmit a partial termination pack through the logarithmic network to the CSU responsively to the partial completion status.

Additionally or alternatively, the DUs are configured to store termination status information in each entry of the task registry and to convey the termination status information in termination packs transmitted through the logarithmic network to the CSU.

At least one of the DUs may include an associative task registry containing a number of entries that is less than the number of the processor cores below the at least one of the DUs in the logarithmic network. Additionally or alternatively, the associative task registry may contain a number of entries that is less than the number of the computing tasks managed by the CSU.

There is also provided, in accordance with an embodiment of the present invention, an apparatus, including a first plurality of processor cores, which are configured, upon becoming available or ceasing to be available to perform a computing task, to transmit availability packs including values that can be positive or negative to indicate addition or removal of the processor cores. A Central Scheduling/Synchronization Unit (CSU) is coupled to allocate computing tasks for execution by the processor cores. A second plurality of Distribution Units (DUs) is arranged in a logarithmic network between the CSU and the processor cores and configured to distribute the computing tasks from the CSU among the processor cores, to convey the availability packs from the processing cores via the logarithmic network to the CSU, and to maintain and modify respective records of the available processor cores in response to the availability packs.

In some embodiments, the CSU is configured to allocate the computing tasks to the available processor cores by transmitting task allocation packs through the DUs in the logarithmic network to the processor cores. Typically, each DU includes a core registry, containing a record of the available processor cores below the DU in the logarithmic network; and a distribution box, configured to divide the task allocation packs received by the DU among the DUs or processor cores in a subsequent layer of the logarithmic network, according to the record of the available processor cores in the core registry.

There is additionally provided, in accordance with an embodiment of the present invention, a method, including providing a first plurality of processor cores and a Central Scheduling/Synchronization Unit (CSU), which is coupled to allocate computing tasks for execution by the processor cores via a second plurality of Distribution Units (DUs) arranged in a logarithmic network between the CSU and the processor cores. The computing tasks are distributed from the CSU among the processor cores via the DUs. Information with regard to the computing tasks distributed to the processor cores is stored in associative task registries maintained by the DUs.

There is further provided, in accordance with an embodiment of the present invention, a method, including providing a first plurality of processor cores and a Central Synchronization Unit (CSU), which is coupled to allocate computing tasks for execution by the processor cores via a second plurality of Distribution Units (DUs) arranged in a logarithmic network between the CSU and the processor cores. Availability packs are transmitted from the processor cores to the logarithmic network when the processor cores become available or cease to be available to perform a computing task. The availability packs include values that can be positive or negative to indicate addition or removal of the processor cores. The availability packs are conveyed through the DUs in the logarithmic network to the CSU. Respective records are maintained and modified at the DUs of the available processor cores in response to the availability packs.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a multiprocessor system, in accordance with an embodiment of the present invention;

FIG. 2 is a block diagram that schematically illustrates a distribution network, in accordance with an embodiment of the present invention;

FIG. 3 is a block diagram that schematically illustrates a distribution unit, in accordance with an embodiment of the present invention;

FIG. 4 is a block diagram that schematically illustrates a core registry, in accordance with an embodiment of the present invention;

FIG. 5 is a block diagram that schematically illustrates an associative task registry, in accordance with an embodiment of the present invention;

FIG. 6 is a block diagram that schematically illustrates an entry (TRE) in the associative task registry, in accordance with an embodiment of the present invention;

FIG. 7 is a block diagram that schematically shows the structure of an allocation count update logic block, in accordance with an embodiment of the present invention;

FIG. 8A is a block diagram that schematically shows the structure of a termination count update logic block, in accordance with an embodiment of the present invention;

FIG. 8B is a block diagram that schematically illustrates a logic cell used in the termination count update logic block of FIG. 8A; and

FIG. 9 is a block diagram that schematically illustrates a distribution logic box, in accordance with an embodiment of the present invention.

### DETAILED DESCRIPTION OF EMBODIMENTS

### Overview

Multiprocessor systems in accordance with embodiments of the present invention allow for efficient parallel execution of multiple computational tasks in a plurality of processor cores. For some of the tasks, multiple instances of the same task can be executed in parallel by multiple processing cores; other tasks have a single instance only. Task allocation to processors is governed by a synchronizer/scheduler, which will be described below. Allocations of new tasks, termination of executing tasks, and addition or removal of processor cores are all handled by a logarithmic distribution network, which uses distributed and associative registries.

Typically, tasks executed by cores access the system memory for instruction and data in order to perform computation. In addition, according to embodiments of the present invention, tasks with a single instance may return a binary value, referred to as Termination Condition (T-COND) below, to the synchronizer/scheduler. The synchronizer/scheduler allocates tasks for execution by the cores; tasks with multiple instances receive an instance number from the synchronizer/scheduler, and may execute concurrently on several cores.

In an embodiment of the present invention, the multiprocessor system is synchronous, using one or more phases of the same clock. A single-phase clock signal is assumed to be wired through all relevant units of the multiprocessor system, but for simplicity is omitted in the figures below. In alternative embodiments, however, dual- and multi-phase clocks may be used, as well as phase-aligned and phase-shifted clock wires having the same frequency or multiples of a reference frequency.

In some embodiments, a global reset is also assumed to be wired through all relevant units of the multiprocessor system but has likewise been omitted from the figures below, for simplicity.

### System Description

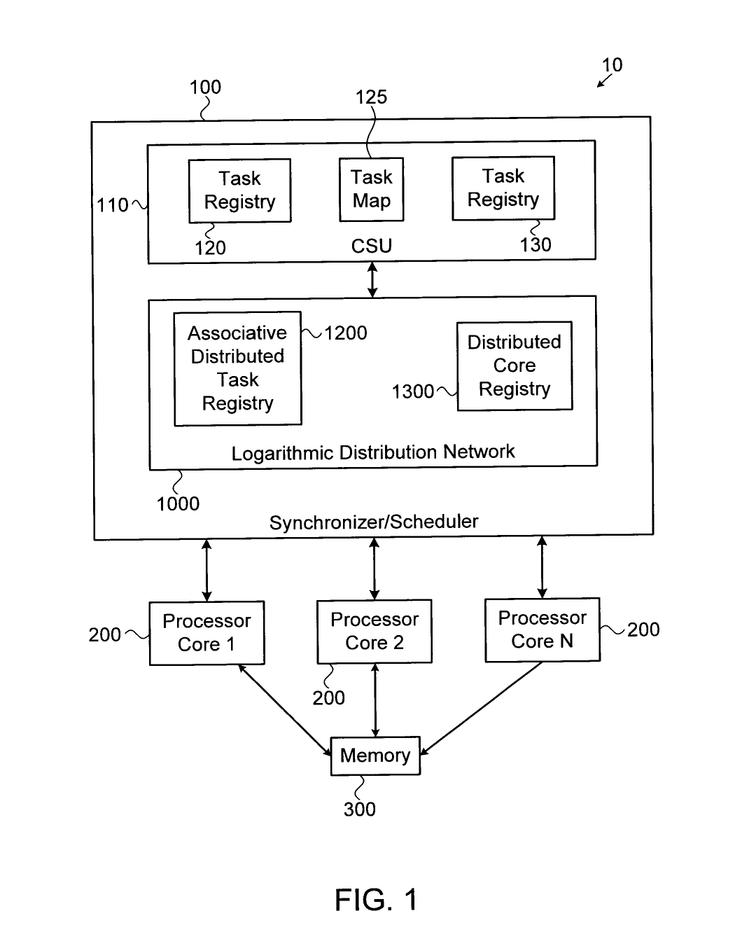

FIG. 1 is a block diagram that schematically illustrates a multiprocessor system 10, in accordance with an embodiment of the present invention. Multiprocessor system 10 comprises at least a synchronizer/scheduler 100 which includes associative arrays (which serve as registries, as described below), a plurality of processor cores 200, and a memory 300. Synchronizer/scheduler 100 allocates computational tasks to one or more available processor cores 200, and keeps updated lists of processor utilization and task execution. Processor cores 200 access memory 300, which may comprise shared and/or non-shared portions. Further details of the structure of system 10 and some of the system components are provided in the above-mentioned U.S. Pat. No. 5,202,987.

Synchronizer/scheduler 100 comprises a Central Synchronizer/scheduler Unit (CSU) 110 and a logarithmic distribution network 1000. CSU 110 comprises, among other elements, a task map 125, where the task dependency is stored, a task registry 120, where the status of the various tasks is stored, and a core registry 130, where the status of the various processor cores 200 is stored. CSU 110 sends allocation packs to logarithmic distribution network 1000, which comprises an associative distributed task registry 1200, and a distributed core registry 1300. Logarithmic distribution network 1000 also comprises other components, as will be detailed below.

Three types of messages propagate from CSU 110 through logarithmic distribution network 1000 to processor cores 200, and from processor cores 200, through network 1000 to CSU 110:
1. Allocation (Alloc) packs propagate from CSU 110 through distribution network 1000 to processor cores 200 and are used to allocate task instances to processor cores;
2. Termination (Term) packs propagate from processor cores 200, through distribution network 1000 to CSU 110, and are used to notify that task instances have been terminated; and
3. Availability (Avail) packs propagate from processor cores 200, through distribution network 1000 to CSU 110, and are used to indicate availability of processor cores 200 to logarithmic distribution network 1000 and to CSU 110. Such Avail packs may be used when processor cores 200 are dynamically added to or removed from the group of processor cores available to perform computational tasks. Addition or removal of cores may be carried out by software control and/or by other means, and require the suspension of new allocations from CSU 110 through logarithmic distribution network 1000 until all core registries are updated.

The term “pack” as used in the context of the present patent application and in the claims means a bundle of information, comprising one or more data fields, which is conveyed from level to level in the logarithmic network.

Processor cores 200 are activated by the above-mentioned Alloc packs and execute tasks, or instances of tasks that can be executed in parallel.

Alloc, Term, and Avail packs are used by logarithmic distribution network 1000 to update distributed core registry 1300 and associative distributed task registry 1200. In the CSU they are used to update task registry 120 and core registry 130.

In some embodiments of the present invention, system 10 is implemented in a single integrated circuit, comprising hardware logic components and interconnects among these components. The integrated circuit may be designed and fabricated using any suitable technology, including full-custom designs and/or configurable and programmable designs, such as an application-specific integrated circuit (ASIC) or a programmable gate array. Alternatively, the elements in system 10 may be implemented in multiple integrated circuits with suitable connections between them. All such alternative implementations of the system principles that are described hereinbelow are considered to be within the scope of the present invention.

### Logarithmic Distribution Network

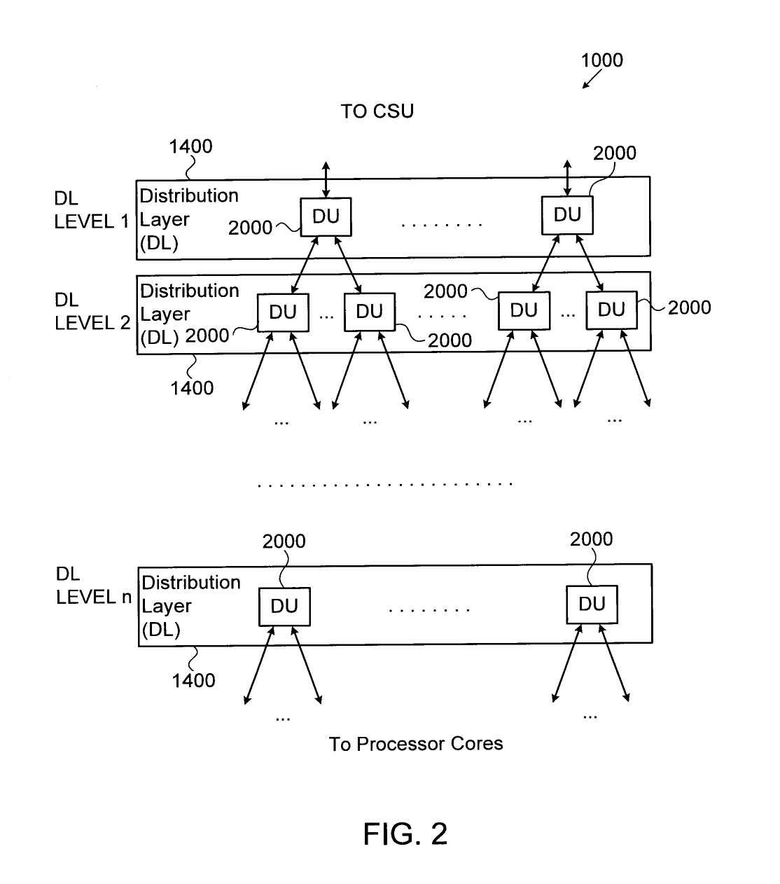

FIG. 2 is a block diagram that schematically illustrates the structure of logarithmic distribution network 1000, in accordance with an embodiment of the present invention.

The term “logarithmic network,” as used in the context of the present patent application and in the claims, refers to a hierarchy of interconnected nodes (which are Distribution Units in the present embodiment) in multiple levels, wherein each node is connected to one parent node in the level above it and to at least one and typically two or more child nodes in the level below it, ending in leaf nodes at the bottom of the hierarchy. The number of nodes in the network is therefore logarithmic in the number of leaf nodes.

Network 1000 comprises a hierarchy of n distribution layers (DL) 1400, wherein n is at least 1 and is typically greater than 1. Each DL 1400 comprises at least one distribution unit (DU) 2000 and typically two or more DUs. The number of DUs 2000 in each DL 1400 typically varies, increasing from layer to layer in the hierarchy. The first DL 1400 below CSU 110 is designated DL Level 1; the second DL 1400 is designated DL Level 2, and, generally, the m^{th} DL 1400 is designated DL Level m.

DL Level 1 is connected to the CSU on one end, and to DL Level 2 on the other end; for any 1≦m≦n, DL Level m is connected to DL Level m−1 on one end, and to DL Level m+1 on the other end; and, DL Level n is connected to DL Level n−1 on one end and to processor cores 200 on the other end.

Each of DU 2000 in DL Level m, for any m greater than 1 and less than n, may connect to a single DU 2000 of DL Level m−1, and to FANOUT DUs 2000 of DL Level m+1. FANOUT is a number greater than or equal to 1, and may vary between DLs 1400 or between DUs 2000 of the same DL 1400. Typically, however, FANOUT is constant over all DUs 2000 in the same level, and equals four, for example.

The structure of distribution network 1000 as described above, guarantees that each DU 2000 in all DLs 1400 will be connected, possibly through other DUs 2000 in higher DL levels (i.e., the DL levels below the DU in the graphical representation of FIG. 2), to a set of processing cores 200. The union of all such sets, connected to all DUs 2000 of a given DL level, contains all processor cores 200 in multiprocessor 10, and all such sets are mutually exclusive.

The set of processor cores 200 which connect to a given DU 2000, will be referred to as the Set of Processor Cores Controlled by the given DU. The number of processor cores 200 controlled by a given DU is the sum of the numbers of processor cores controlled by all DUs 2000 connected to the given DU in a DL level higher by 1 than the level of the DL to which the given DU belongs.

In order to improve clarity, we note here that associative distributed task registry 1200 and distributed cores registry 1300, illustrated in FIG. 1 as sub-units of logarithmic distribution network 1000, are not explicitly illustrated in FIG. 2; rather, as shown in the figures that follow, they are distributed within DUs 2000 of DLs 1400 which form logarithmic distribution network 1000.

Alloc packs, requesting allocation of processor cores to task instantiations, propagate down through DLs 1400. In each DU 2000 in any DL level, the input Alloc pack is used to generate partial output Alloc packs, which are sent to DUs 2000 in the DL level below.

Avail packs, which carry information on availability of processor cores 200 from the group of processor cores controlled by the DU 2000, propagate through DLs 1400 towards CSU 110. In each DU 2000 in any DL level, FANOUT Avail packs are merged, and a combined Avail pack is generated and sent to a DU 2000 in the DL level above

Term packs, which carry information on terminating task instantiations, also propagate through DLs 1400 towards CSU 110. DUs 2000 in any DL level generate merged Term packs corresponding to terminating tasks executing in processor cores controlled by the DU 2000.

Alloc, Avail and Term packs also change the contents of task registry 120 and core registry 130 in CSU 110, and of associative distributed task registry 1200 and distributed core registry 1300 in logarithmic distribution network 1000, as will be explained below.

### Distribution Unit

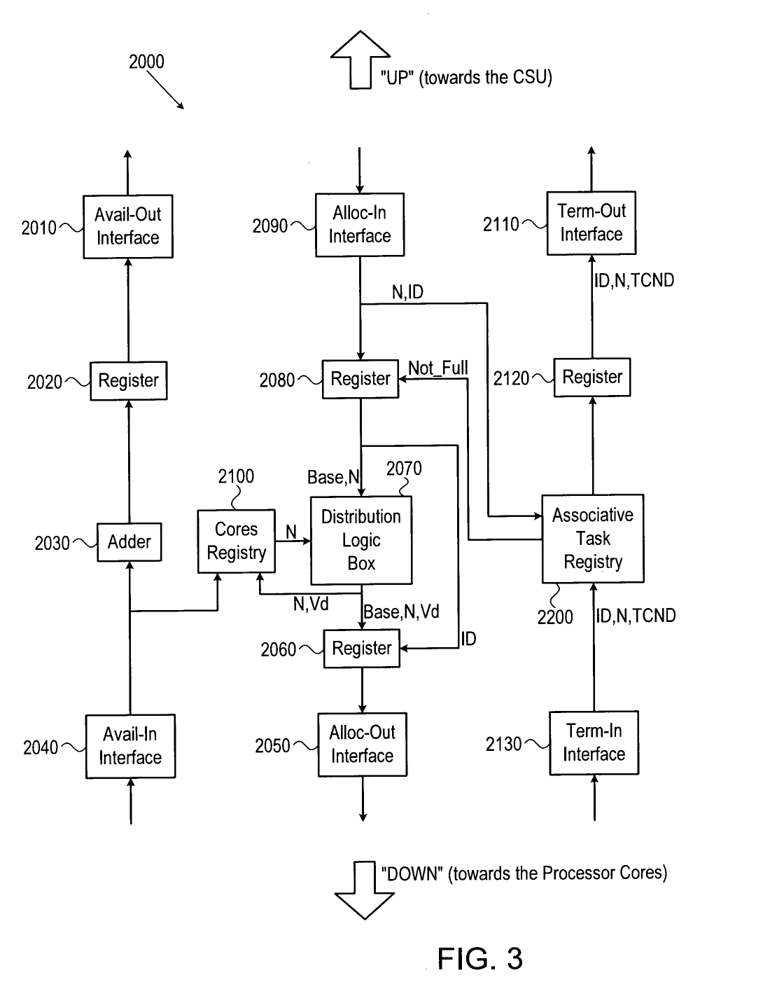

FIG. 3 is a block diagram that schematically illustrates distribution unit (DU) 2000, in accordance with an embodiment of the present invention. For easy reference below, we define, for a given DU 2000 in a DL 1400 of a given DL Level m, UP and DOWN directions: UP is connection to a DU 2000 in a DL 1400 of a DL level lower than m, or to CSU 110 if m equals 1; and DOWN is connection to a DU 2000 in a DL 1400 of DL level higher than m, or to processors cores 200 if m equals n. We will further refer to the DU connected to a given DU in the UP direction as the DU ABOVE the given DU; and to the DU connected to a given DU in the DOWN direction as the DU BELOW the given DU 2000.

Input packs, which may comprise Alloc, Term and Avail packs, propagate through DU 2000 of DL's 1400. Each DU 2000 gets input packs, typically modifies such packs, and sends them to a DU 2000 of the next DL 1400. Alloc packs propagate from CSU 110 in the DOWN direction toward processor cores 200; Term packs propagate in the UP direction towards CSU 130; and Avail packs propagate in the UP direction towards CSU 110.

Accordingly, DU 2000 has three interfaces in the UP direction: Alloc-In interface 2090, for the propagation of task allocation packs, Term-Out interface 2110, for propagation of termination packs, and Avail-Out interface 2010, for propagation of processor availability packs. Similarly, DU 2000 has three interfaces in the DOWN direction: Alloc-Out interface 2050, Term-In interface 2130, and Avail-In interface 2040. Typically, pack propagation through each DU 2000 takes one clock cycle. Propagation time through an N-level distribution network 1000 is proportional to N, which is proportional to the log of the number of processing cores 200.

In a disclosed embodiment of the present invention, Avail-Out interface 2010 comprises wires on which a 2's complement binary number is asserted. The number indicates changes in the number of available processor cores 200 in the set of Processor Cores controlled by the given DU; it will be positive when the number increases, negative when it decreases, and 0 when the number of available processor cores 200 remains unchanged.

Avail-Out interfaces from FANOUT DUs 2000 BELOW a given DU connect to a single Avail-In interface 2040 of the given DU. An adder 2030 may sum the Avail-In numbers arriving from the FANOUT DUs, to form an Avail-Out number, representing the total change in the number of available processor cores controlled by the given DU. This number may be stored in a register 2020, and asserted on Avail-Out interface 2010 in the next clock cycle.

In a disclosed embodiment of the present invention, Term-Out interface 2110 comprises an ID field indicating, at any given clock cycle, the binary ID code of a task for which some instantiations are terminated, an N field indicating the number of instantiations of the task that terminated at the given clock cycle, and a Valid bit, indicating that the information in the other fields is valid. In some embodiments, an additional T-COND bit is added, and used by terminating non-parallel tasks to return a binary parameter, referred to as T-COND, to the CSU. The Valid bit may be omitted from Term-In interface 2130 of DUs 2000 of DL Level n, and considered to be always on.

Term-Out interface units 2110 of FANOUT DUs are connected to Term-In interface 2130 of a single DU above them. Wires from Term-In interface 2130 connect to associative task registry (ATR) 2200, which will be described further below. ATR 2200 generates Term-Out packs, which are stored in a register 2120, and become output in the next clock cycle through Term-Out interface 2110.

Instantiations of a single task that may be allocated to several processor cores 200 are provided with a base allocation index number (BASE) and the number of instances (N), which represent an incremental series in the range of BASE to (BASE+N−1). In embodiments of the present invention, Alloc-In interface 2090 of DU 2000 comprises an ID field indicating, at any clock cycle, the binary ID code of a task to be allocated, a BASE field indicating the allocation index number, an N field indicating the number of instances of the task that are to be allocated, and a Valid bit indicating that data in the other fields is valid. Alloc-In Interface 2090 may also include an Accept wire, indicating to the DU asserting a corresponding Alloc-Out pack that the pack has been accepted. Accept may not be generated when an Alloc pack is received, but ATR 2200 is full, as indicated by a Not_Full output of ATR 2200, and described further below.

In some embodiments, for some or for all DUs 2000, ATR 2200's Not_Full output is omitted. This may be the case if the number of processor cores controlled by the DU is less than or equal to the number of entries in the ATR, or if it is guaranteed by the allocation scheme that Alloc-Out packs will be sent only to DUs which can accept it at the same clock cycle. In those cases, register 2080, and/or the Accept output of Alloc-In interface 2090 may be omitted.

According to embodiments of the present invention, Alloc-Out interface 2050 of DU 2000 has the same fields as Alloc-In interface 2090 described above. Alloc-Out packs are stored in a register 2060. The ID field in register 2060 is identical to the ID field received from register 2080 which is a sampled value of Alloc-In interface 2090.

The Base and N fields are generated in a distribution logic box 2070, according to information from register 2080 (or directly from Alloc-In interface 2090, if register 2080 is omitted), and from a core registry 2100 (to be described below).

### Core Registry

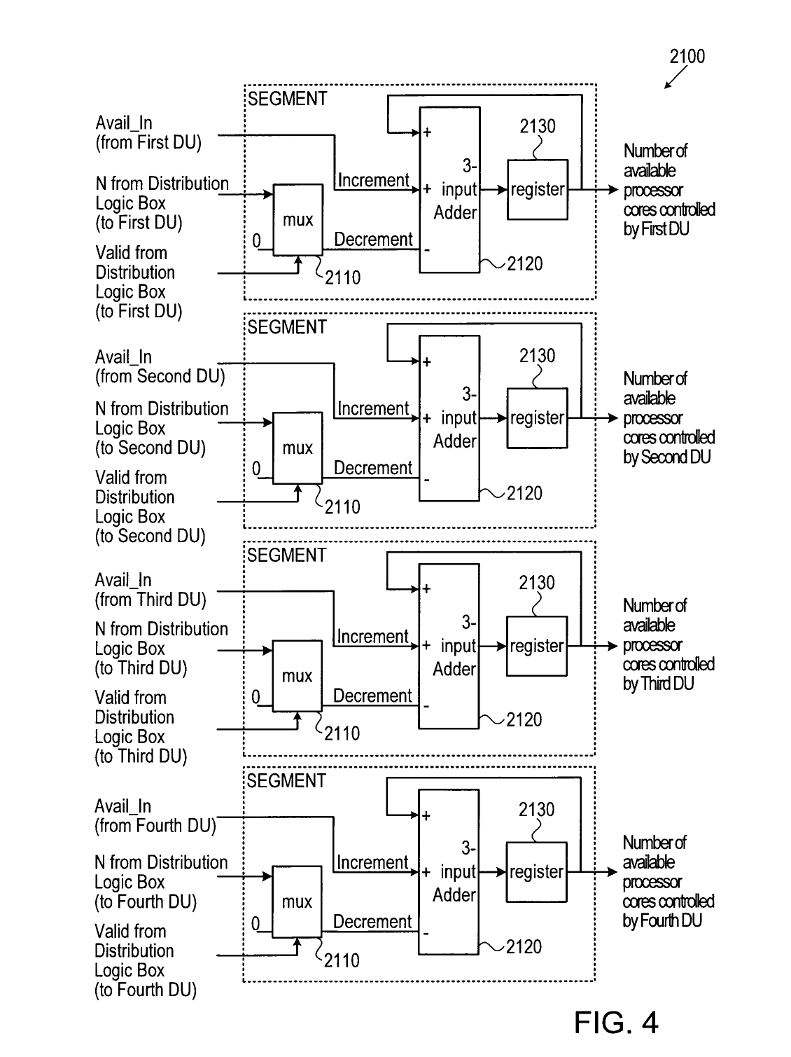

FIG. 4 is a block diagram that schematically illustrates core registry 2100 according to an embodiment of the present invention. Core registry 2100 comprises FANOUT identical segments, serving the FANOUT DUs 2000 located BELOW the DU 2000 incorporating the pictured core registry. In the pictured embodiment, FANOUT equals 4, and core registry 2100 comprises four identical segments.

Each segment of core registry 2100 comprises a register 2130, which, at all times, stores the number of available processor cores controlled by the DU 2000 into which instances of tasks can be allocated.

Each segment of core registry 2100 further comprises a three-input-adder 2120, which adds to the contents of register 2130 an Increment value, received from the Avail-In interface (which can be negative), and subtracts a Decrement value N, received from a MUX 2110. MUX 2110 receives the value N from distribution logic box 2070 if an accompanying Valid bit received from the distribution logic box is set, and forces Decrement value to 0 when the Valid bit is not set. The result of three-input adder 2120 is written into register 2130.

### Associative Task Registry

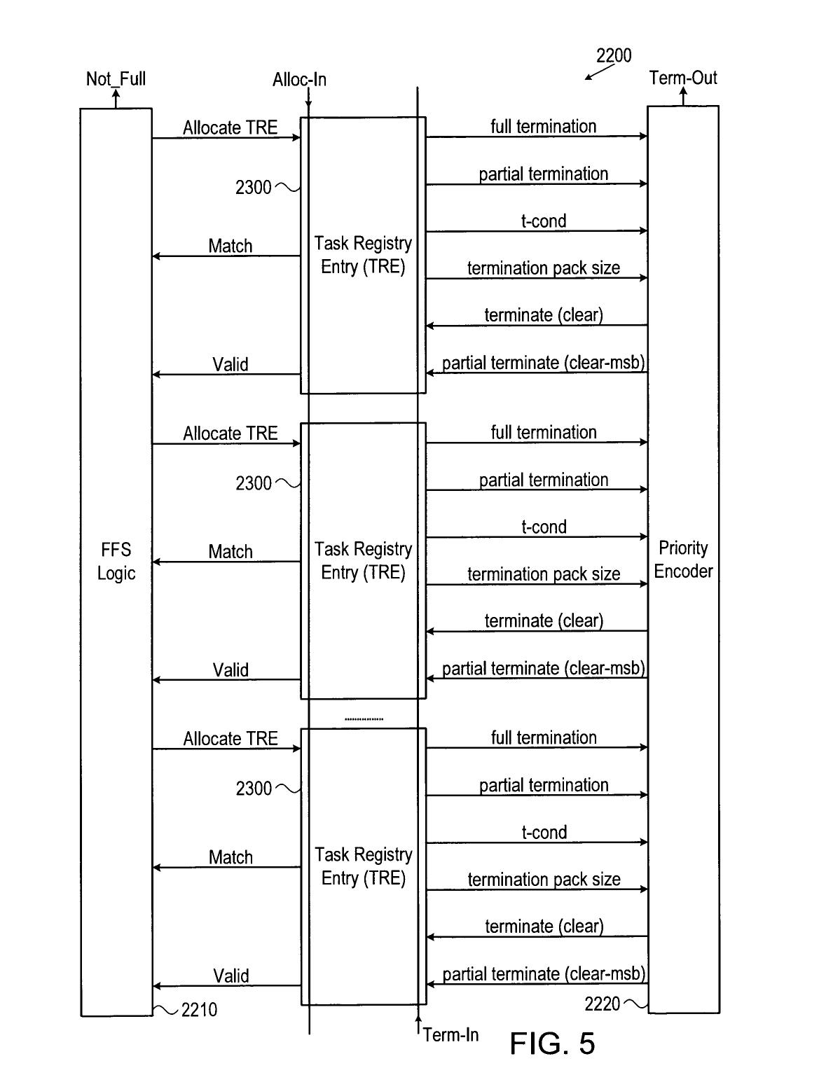

FIG. 5 is a block diagram that schematically illustrates associative task registry (ATR) 2200 in accordance with an embodiment of the present invention.

ATR 2200 stores information regarding computing tasks distributed by DU 2000 to the levels below it in network 1000 (and ultimately to the processor cores) in associative memory entries (registry entries). These entries are “associative” in the sense that the information they contain is addressed by comparing, in parallel, the contents of multiple entries to keys (in this case task identifiers provided by an allocation or termination pack), rather than by an explicit, physical memory address as in conventional random access memories. The use of associative memory to implement the distributed task registry in logarithmic distribution network 1000 facilitates efficient use of the memory resources in the network, in terms of both minimizing the amount of memory required by the distribution units to keep track of computing tasks and enabling fast (single clock cycle) access to all the task entries in parallel.

ATR 2200 comprises multiple associative Task Registry Entries (TREs) 2300, a find-first-set unit (FFS) 2210, and a priority encoder 2220.

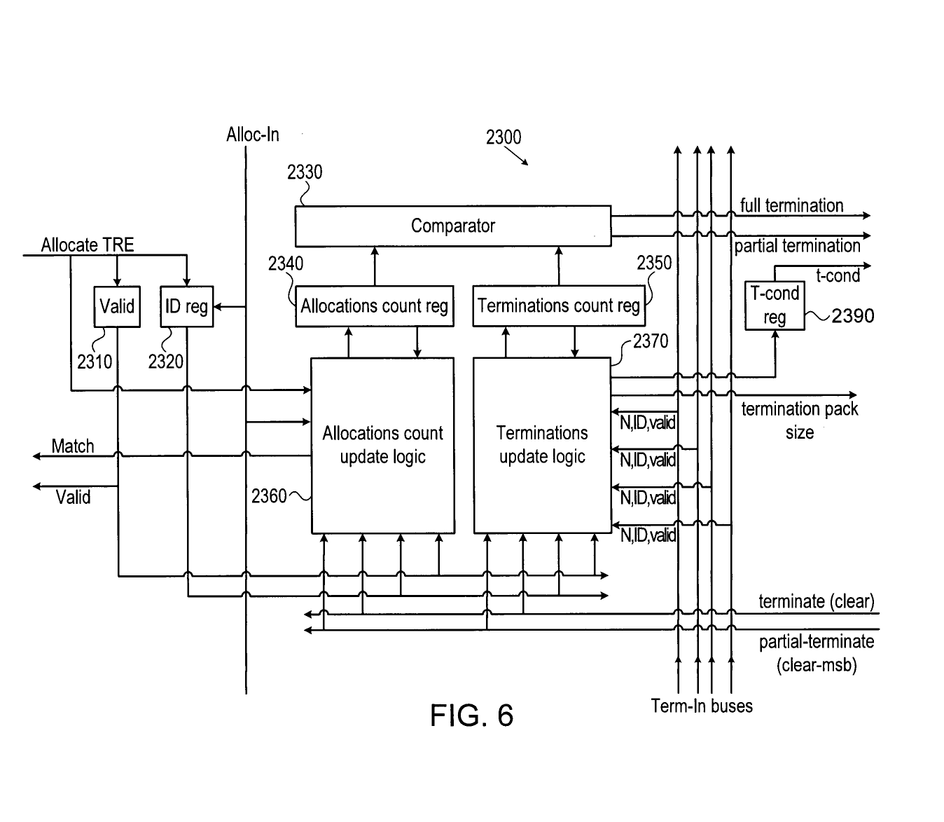

FIG. 6 is block diagram of TRE 2300, in accordance with an embodiment of the present invention. Each TRE 2300 may or may not hold, at each clock cycle, a valid entry, as indicated by a single bit value stored in valid register 2310. When valid register 2310 is set, TRE 2300 stores information related to a computing task executed by one or more processor cores 200 controlled by the DU in which the ATR is located: the task ID is stored in an ID register 2320, an allocation count register 2340 stores the number of instantiations of the task, a termination count register 2350 stores the number of terminated tasks, and a T-COND register 2390 holds a return value of the task, which is relevant only for tasks with a single instantiation.

The contents of allocation count register 2340 are read and updated by allocation count update logic 2360, while the contents of termination count register 2350 are read and updated by termination update logic 2370.

A comparator 2330 compares the contents of registers 2340 and 2350 in order to generate a full termination or partial termination output. The full termination output is asserted when the values of allocation count register 2340 and termination count register 2350 are equal; the partial termination output is asserted when the most significant bits of allocation count register 2340 and termination count register 2350 are equal, but the other bits are not. These count registers enable DU 2000 to keep track of the number of instances of each computing task that it has allocated to the levels below it in network 1000 and the number of these task instances that have been completed by the processor cores.

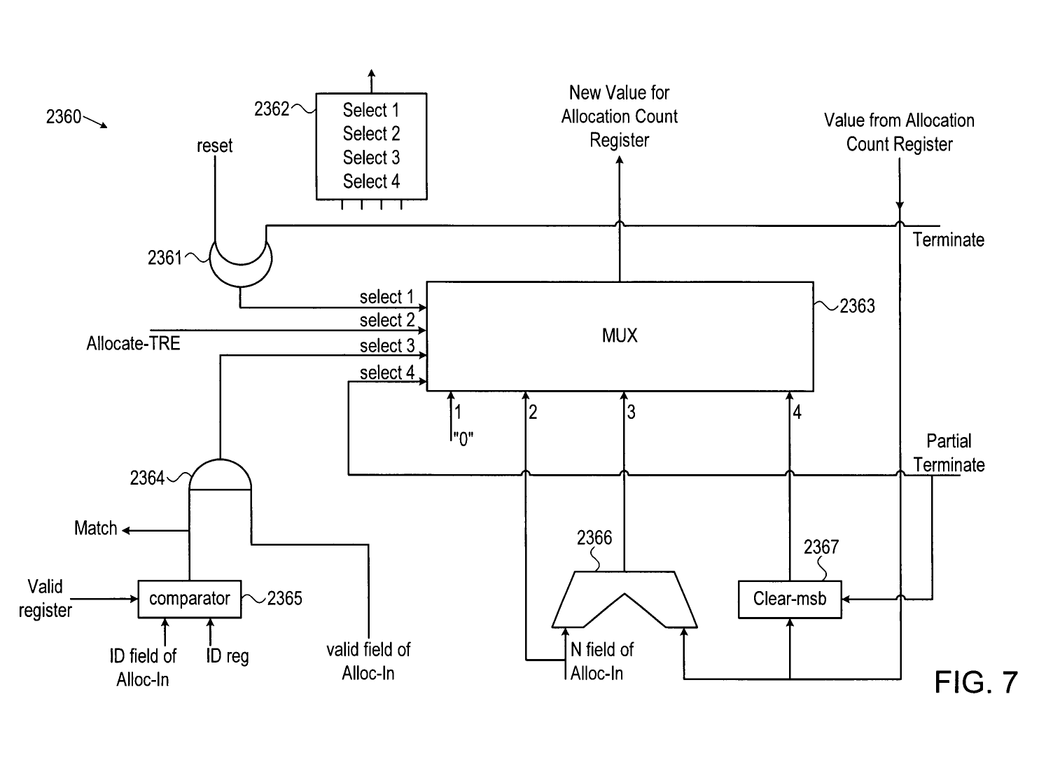

FIG. 7 schematically illustrates the structure of allocation count update logic 2360, in accordance with an embodiment of the present invention. A MUX 2363 selects data to be written into allocation count register 2340 from one of four data inputs, numbered 1 to 4: Input 1 provides a binary zero; input 2 provides the N field of the input Alloc-In pack; input 3 provides the sum of the current value in allocation count register 2340 and the N field of the input Alloc-In pack, summed by an adder 2366; and input 4 provides the current value in allocation count register 2340 with its msb forced to logic 0 by a clear-msb unit 2367.

MUX 2363 has four select inputs, designated Select 1 to Select 4. When a certain Select input is asserted, MUX 2363 selects the corresponding data input, and forwards its contents to the MUX output, to be written into allocation count register 2340. An Or gate 2362 generates a Write output to allocation Count Register 2340 if any of Select 1 through Select 4 is asserted.

The select inputs are generated as follows: Select 1 is asserted by an Or gate 2361 if either a general reset input is asserted or if Terminate is signaled by priority encoder 2220. Select 2 is asserted if an Allocate-TRE is input from FFS 2210. Select 3 is asserted by an And gate 2364 if the Valid bit of the Alloc-In input is asserted and if a comparator 2365 asserts a Match output, indicating that the contents of ID register 2320 match the ID field of the Alloc-In input pack, and Valid register 2310 is at logic 1. Select 4 is asserted if a Partial-Terminate input is asserted by priority encoder 2220.

The Match output of comparator 2365, indicating, as explained above, ID match and set valid register 2310, is also input to FFS logic 2210.

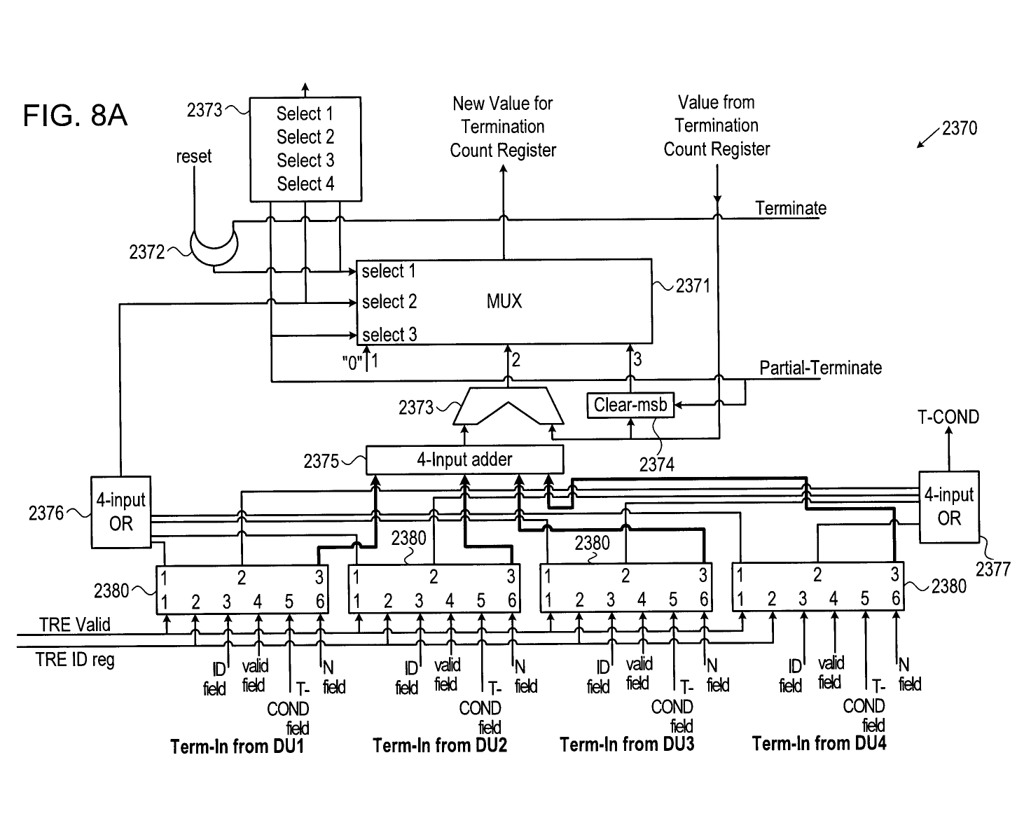

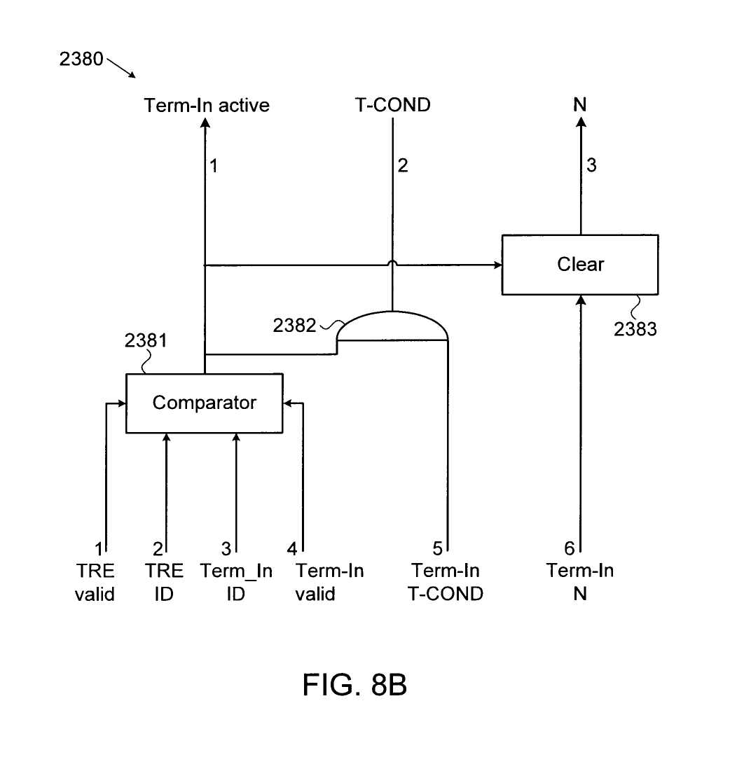

FIGS. 8A and 8B schematically illustrate the structure of termination update logic 2370, which writes new values into termination count register 2350, in accordance with an embodiment of the present invention.

A MUX 2371 selects the new value from one of its three data inputs, designated 1, 2, and 3, as controlled by control inputs Select 1, Select 2 and Select 3, respectively. The inputs are set as follows: Select 1 input to MUX 2371 is asserted by an Or gate 2372 when either a Terminate input is asserted by priority encoder 2220, or a general reset input is asserted; data input 1 is wired to a value representing binary 0. Select 2 is asserted by a four-input Or gate 2376 when a number of instances of a task are terminated and the value in termination count register 2350 is to be incremented by this number, which is provided by data input 2. Select 3 is asserted when a Partial-Terminate input is asserted by priority encoder 2220. Data input 3 is driven by a clear-msb unit 2374, which transfers its input to its output if the Partial Terminate input is not asserted, and clears the most significant bit of the input from termination count register 2350, leaving the other bits unchanged, otherwise. A Write signal is asserted when any of Select 1, Select 2 or Select 3 is asserted, as detected by a three-input Or gate 2373.

When any or all of the FANOUT Term-In inputs carry a termination pack that matches the task whose identifier is held in a given TRE 2300, the number of terminated instances is provided by data input 2 to MUX 2371 for addition to the current value of termination count register 2350. For this purpose, each of the FANOUT Term-In inputs is connected to an identical Cell 2380, detailed in FIG. 8B. A comparator 2381 compares the ID field in ID register 2320 with the ID field of the Term-In input, and asserts the Term-In Active output of cell 2380 if the two values match, and both valid register 2310 and the valid field of the Term-In input are at logic 1. A clear unit 2383 forces an Output N of cell 2380 to binary value 0 if the Term-In Active output is not asserted, and to the value of the Term-In N field otherwise. Finally, an And gate 2382 outputs the T-COND field of the Term-In input on the T-COND output of cell 2380 if the Term-In Active output is asserted, and a logic 0 otherwise.

In the embodiment shown in FIG. 8A, the Term-In Active outputs of four Cells 2380 are connected to the four Term-In inputs of Or gate 2376. The N outputs of cells 2380 are connected to a four-input adder 2375, and their sum is added to the value of termination count register 2350 by a adder 2373, and asserted at data input 2 of MUX 2371. The four T-COND outputs of cells 2380 are input to a four-input-or gate 2377, which generates the value of T-COND for the Term-Out pack to be output by priority encoder 2220. This value is stored in register 2390 (FIG. 6) when the termination count register 2350 is written into. The four Term-In Active outputs of cells 2380 are input to a four-input-or gate 2376, which generates the Select 2 input of MUX 2371.

Referring back now to FIG. 5, for each new task received by ATR 2200, FFS Logic 2210 selects the first available TRE 2300 for allocation of the task. The term “first,” in the present context, applies to some arbitrary order of the otherwise identical TREs 2300. FFS Logic 2210 checks that all Match lines from all TREs 2300 are false with respect to the task ID, and hence allocation of a new TRE 2300 is needed. If any of the Match inputs is asserted, which indicates that no allocation is needed, FFS logic 2210 drives all its Allocate TRE outputs with logic 0, and no new TRE 2300 will be allocated. If no Match input is asserted, then the first TRE 2300 whose Valid output is not asserted, indicating that the TRE is free, will be selected, and its Allocate TRE input will be asserted by FFS logic 2210. The FFS Logic may select the first free TRE 2300 using combinatorial find-first-set logic, for example.

In the case where no match signal is set, and all valid signals are set, a NOT_FULL indication will be cleared. This indication is used by embodiments of the present invention which implement fewer TRE then cores controlled by a DU 2000. The NOT_FULL output is translated to a negative response to the CSU 110 that prevent the allocation transaction on Alloc-In 2090 interface from completion.

Priority encoder 2220 gets two indication outputs—full termination and partial termination, from each TRE 2300, indicating that the TRE requests to send a Term-out termination pack to the DU 2000 in the UP direction. In addition, the TRE asserts the number of terminated tasks on a termination pack size bus, and asserts a T-COND line with the value of the return parameter T-COND. Priority Encoder 2220 selects one TRE 2300 that has set its full-termination or partial-termination output, and asserts the values of its termination pack size and T-COND outputs on a Term-Out output of priority encoder 2220.

If more than one TRE 2300 asserts its full-termination or partial-termination output, Priority Encoder 2200 selects one of these TREs using a predetermined priority scheme, such as a rotating or fixed priority scheme.

Priority Encoder 2220 may notify the selected TRE 2300 that its request to send a full or partial termination pack has been executed by asserting a Terminate (clear) or a Partial Terminate (clear-msb) input of the selected TRE.

### Distribution Box

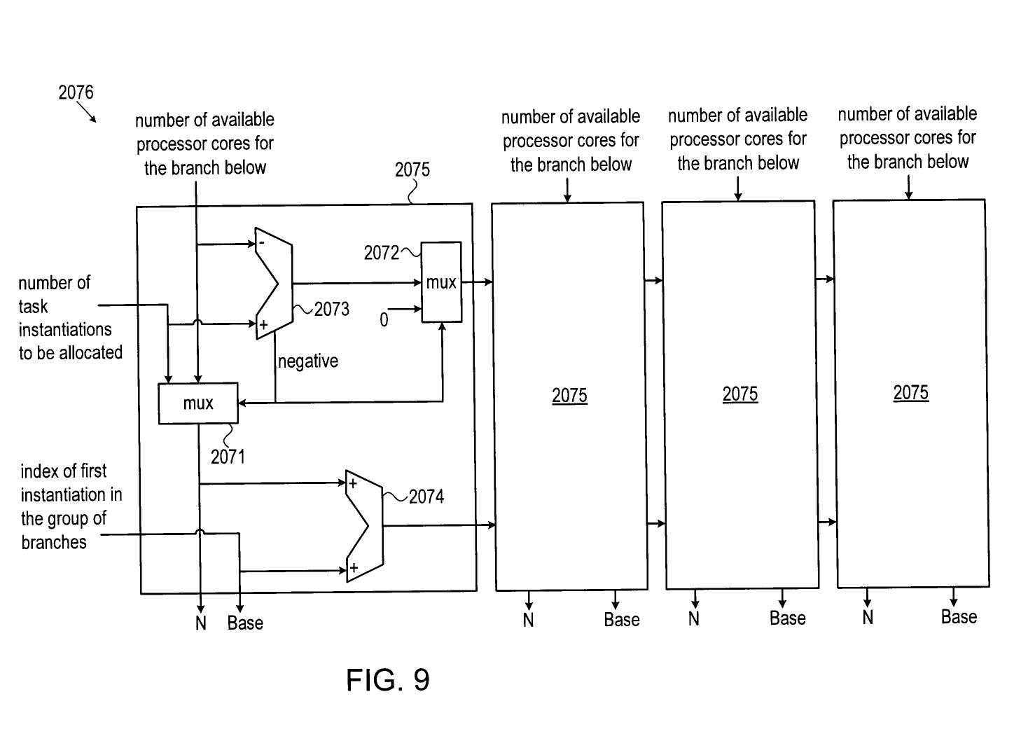

FIG. 9 schematically shows details of distribution box 2070, according to an embodiment of the present invention. The purpose of distribution box 2070 is to distribute the Alloc-In pack to FANOUT Alloc-out packs, output to the four DUs 2000 below, according to the number of available processor cores controlled by each of them.

Distribution box 2070 generates the N and the Base fields of allocation packs which are sent to DUs 2000 BELOW the DU 2000 in which distribution box 2070 is located. Distribution box 2070 receives as inputs the numbers of available processor cores 200 controlled by each of DUs 2000 BELOW the DU 2000 in which distribution box 2070 is located. The distribution box also receives the N and Base field values from the Avail-In interface 2040 (FIG. 3), which represent the number of task instances to be allocated and the index of the lowest task instance, respectively.

In the pictured embodiment, distribution box 2070 comprises four identical cells 2075, which are chained together. Each cell 2075 receives the Base and N values from the previous cell, to be allocated by the cell and by the cells that follow it in the chain (shown to its right in FIG. 9). Each cell 2075 generates the N and the Base fields sampled by register 2060, and then connected to the Alloc-out interface 2050 connected to a DU 2000 BELOW the DU 2000 in which distribution box 2070 is located. In addition, each cell 2075 outputs to the next cell in the chain a remaining N field, whose value equals the N field at its input, decremented by the number of instantiations allocated by cell 2075, and an accumulated Base field, whose value equals the sum of the Base field at its input and the number of instantiations allocated by the cell 2075.

Each cell 2075 comprises a subtractor 2073, a MUX 2072, a MUX 2071 and an adder 2074. Subtractor 2073 subtracts the number of available processor cores indicated by core registry 2100 from the input N field. MUX 2072 asserts the N output of cell 2075, which is input to the cell 2075 at its right. MUX 2072 selects the output of subtractor 2073 if the subtraction result is positive, and selects a binary 0 if the result is negative, meaning no more allocations are needed. MUX 2071 drives the N field of the Alloc-Out interface with the value from the N input if the result of subtractor 2073 is negative, or with the value of the number of available processors that cell 2075 received as input if the result is positive.

Distribution box 2070 may include a pipeline stage (not shown), which delays the generation of the Alloc-Out message one or more clock cycles after the Alloc-In message. For example, a one-clock delay is inserted in each cell 2075.

The Valid bit of the Alloc-In message is output from cells 2075 (not shown) either directly or, in embodiments in which a pipeline delay is introduced, after a similar pipeline delay.

Although the circuits shown in the preceding figures represent a particular implementation of an associative Distribution Unit that the inventors have found to be useful, alternative implementations of these associative principles will be apparent to those skilled in the art after reading the foregoing description and are considered to be within the scope of the present invention. Thus, it should be understood that the embodiments described above are cited only by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. An apparatus, comprising:
a first plurality of processor cores;
a Central Scheduling/Synchronization Unit (CSU), which is coupled to allocate computing tasks for execution by the processor cores; and
a second plurality of Distribution Units (DUs), arranged in a logarithmic network between the CSU and the processor cores and configured to distribute the computing tasks from the CSU among the processor cores, each DU comprising an associative task registry for storing information with regard to the computing tasks distributed to the processor cores by the DU.

2. The apparatus as in claim 1, wherein the CSU is configured to allocate the computing tasks by transmitting task allocation packs through the DUs in the logarithmic network to the processor cores.

3. The apparatus as in claim 2, wherein each DU comprises a distribution box, which is configured to distribute the task allocation packs received by the DU among the DUs or processor cores in a subsequent level of the logarithmic network within a number clock cycles no greater than the number of the DUs or processor cores in the subsequent level.

4. The apparatus as in claim 1, wherein the processor cores are configured, upon completing a computing task, to transmit task termination packs through the DUs in the logarithmic network to the CSU.

5. The apparatus as in claim 4, wherein the DUs are configured to merge termination information contained in the termination packs and to convey the merged termination information to the CSU.

6. The apparatus as in claim 5, wherein the DUs are configured to transmit one of the merged termination packs in each clock cycle, with a latency of a single clock cycle.

7. The apparatus as in claim 1, wherein the processor cores are configured, upon becoming available or upon ceasing to be available to perform the computing tasks, to transmit availability packs through the DUs in the logarithmic network to the CSU.

8. The apparatus as in claim 7, wherein each DU comprises a core registry, which is configured to keep track of the available processor cores responsively to the availability packs and to allocation packs transmitted by the CSU.

9. The apparatus as in claim 1, wherein the associative task registry of each DU comprises multiple entries, each entry corresponding to a respective computing task distributed by the DU to the processor cores and comprising an ID register, storing a unique code for the computing task, which is applied by the DU in associatively accessing the entries.

10. The apparatus as in claim 9, wherein each entry in the associative task registry further comprises:
an allocation count register, configured to keep a first count of the number of task instantiations allocated to the processor cores by the DU;
a termination count register, configured to keep a second count of the number of the task instantiations for which the DU has received a termination pack; and
a comparator, coupled to compare the first and second counts in order to determine a completion status of the respective computing task.

11. The apparatus as in claim 10, wherein the DUs are configured to detect a partial completion status responsively to the allocation and termination count registers and to transmit a partial termination pack through the logarithmic network to the CSU responsively to the partial completion status.

12. The apparatus as in claim 9, wherein the DUs are configured to store termination status information in each entry of the task registry and to convey the termination status information in termination packs transmitted through the logarithmic network to the CSU.

13. The apparatus as in claim 1, wherein at least one of the DUs comprises an associative task registry containing a number of entries that is less than the number of the processor cores below the at least one of the DUs in the logarithmic network.

14. The apparatus as in claim 1, wherein at least one of the DUs comprises an associative task registry containing a number of entries that is less than the number of the computing tasks managed by the CSU.

15. An apparatus, comprising:
a first plurality of processor cores, which are configured, upon becoming available or ceasing to be available to perform a computing task, to transmit availability packs comprising values that can be positive or negative to indicate addition or removal of the processor cores;
a Central Scheduling/Synchronization Unit (CSU), which is coupled to allocate computing tasks for execution by the processor cores; and
a second plurality of Distribution Units (DUs), arranged in a logarithmic network between the CSU and the processor cores and configured to distribute the computing tasks from the CSU among the processor cores, to convey the availability packs from the processing cores via the logarithmic network to the CSU, and to maintain and modify respective records of the available processor cores in response to the availability packs.

16. The apparatus as in claim 15, wherein the CSU is configured to allocate the computing tasks to the available processor cores by transmitting task allocation packs through the DUs in the logarithmic network to the processor cores.

17. The apparatus as in claim 16, wherein each DU comprises:
a core registry, containing a record of the available processor cores below the DU in the logarithmic network; and
a distribution box, configured to divide the task allocation packs received by the DU among the DUs or processor cores in a subsequent layer of the logarithmic network, according to the record of the available processor cores in the core registry.

18. The apparatus as in claim 15, wherein the processor cores are configured, upon completing a computing task, to transmit task termination packs through the DUs in the logarithmic network to the CSU.

19. A method, comprising:
providing a first plurality of processor cores and a Central Scheduling/Synchronization Unit (CSU), which is coupled to allocate computing tasks for execution by the processor cores via a second plurality of Distribution Units (DUs) arranged in a logarithmic network between the CSU and the processor cores;
distributing the computing tasks from the CSU among the processor cores via the DUs; and
storing information with regard to the computing tasks distributed to the processor cores in associative task registries maintained by the DUs.

20. The method as in claim 19, wherein distributing the computing tasks comprises transmitting task allocation packs through the DUs in the logarithmic network to the processor cores.

21. The method as in claim 20, wherein transmitting the task allocation packs comprises distributing the task allocation packs received by a DU among the DUs or processor cores in a subsequent level of the logarithmic network within a number clock cycles no greater than the number of the DUs or processor cores in the subsequent level.

22. The method as in claim 19, and comprising, upon completing a computing task in a processor core, transmitting task termination packs from the processor core through the DUs in the logarithmic network to the CSU.

23. The method as in claim 22, wherein transmitting the task termination packs comprises merging termination information contained in the termination packs at the DUs and conveying the merged termination information to the CSU.

24. The method as in claim 23, wherein the DUs are configured to transmit one of the merged termination packs in each clock cycle, with a latency of a single clock cycle.

25. The method as in claim 19, and comprising transmitting availability packs from the processor cores through the DUs in the logarithmic network to the CSU when the processor cores become available or cease to be available to perform the computing tasks.

26. The method as in claim 25, wherein each DU comprises a core registry, which is configured to keep track of the available processor cores responsively to the availability packs and to allocation packs transmitted by the CSU.

27. The method as in claim 19, wherein storing the information comprises maintaining multiple entries in the associative task registry of each DU, each entry corresponding to a respective computing task distributed by the DU to the processor cores and comprising an ID register, storing a unique code for the computing task, which is applied by the DU in associatively accessing the entries.

28. The method as in claim 27, wherein maintaining the multiple entries comprises, for each of the entries:
keeping a first count of the number of task instantiations allocated to the processor cores by the DU in an allocation count register;
keeping a second count of the number of the task instantiations for which the DU has received a termination pack in a termination count register;
comparing the first and second counts in order to determine a completion status of the respective computing task.

29. The method as in claim 28, wherein the method comprises detecting, at the DUs, a partial completion status responsively to the allocation and termination count registers, and transmitting a partial termination pack through the logarithmic network to the CSU responsively to the partial completion status.

30. The method as in claim 27, wherein maintaining the multiple entries comprises storing termination status information in each entry of the task registry, and conveying the termination status information in termination packs transmitted through the logarithmic network to the CSU.

31. The method as in claim 19, wherein storing the information comprises maintaining, in at least one of the DUs, an associative task registry containing a number of entries that is less than the number of the processor cores below the at least one of the DUs in the logarithmic network.

32. The method as in claim 19, wherein storing the information comprises maintaining, in at least one of the DUs, an associative task registry containing a number of entries that is less than the number of the computing tasks managed by the CSU.

33. A method, comprising:
providing a first plurality of processor cores and a Central Synchronization Unit (CSU), which is coupled to allocate computing tasks for execution by the processor cores via a second plurality of Distribution Units (DUs) arranged in a logarithmic network between the CSU and the processor cores;
transmitting availability packs from the processor cores to the logarithmic network when the processor cores become available or cease to be available to perform a computing task, the availability packs comprising values that can be positive or negative to indicate addition or removal of the processor cores;
conveying the availability packs through the DUs in the logarithmic network to the CSU; and
maintaining and modifying respective records at the DUs of the available processor cores in response to the availability packs.

34. The method as in claim 33, and comprising distributing the computing tasks by transmitting task allocation packs from the CSU through the DUs in the logarithmic network to the processor cores.

35. The method as in claim 34, wherein transmitting the task allocation packs comprises dividing the task allocation packs received by each DU among the DUs or processor cores in a subsequent layer of the logarithmic distribution network, according to the respective records of the available processor cores.

36. The method according to claim 33, and comprising transmitting task termination packs from the processor cores through the logarithmic network when the processor cores complete the allocated computing tasks.
